(19) United States
(12) Patent Application Publication
(10) Pub. No.: US 2013/0047808 A1
(43) Pub. Date: Feb. 28, 2013

(54) Punching and Forming Lubrication System and Lubricant Retention Matrix

(71) Applicant: Ronald C. Windingstad, White Bear Township, MN (US)

(72) Inventor: Ronald C. Windingstad, White Bear Township, MN (US)

(73) Assignee: MATE PRECISION TOOLING INC., Anoka, MN (US)

(21) Appl. No.: 13/215,604

(22) Filed: Aug. 23, 2011

(51) Int. Cl. B21D 45/08; B23P 11/00; B21D 37/18; B26D 7/08; B26D 7/12

(52) U.S. Cl. 83/136; 72/43; 83/174; 29/432

(57) ABSTRACT

A punch element is mounted for sliding movement in the guide sleeve or casing with the punch point at its lower end for forming or punching a workpiece. A stripper element is located at the lower end of the guide sleeve which defines the casing of the punch assembly, and the stripper element has an opening aligned with the punch point through which the punch point passes to engage the workpiece. A matrix placement chamber is provided within the casing between the punch point and the guide sleeve so as to at least partially surround the punch point and at least one flexible lubrication matrix body is contained in the matrix placement chamber inside the housing. The matrix which is enclosed entirely within the casing of the unitary punch assembly in which the punch reciprocates comprises an integral porous elastic multi-cellular polymeric body containing a multiplicity of hollow communicating cells adapted to hold a lubricant in fluid communication with the sidewalls of at least the point of the punch and in a preferred form completely surrounds the punch point. The lubrication matrix can also hold a cleaning agent or an abrasive in particulate form.

### FIELD OF THE INVENTION

This invention relates to punching and forming, and more particularly to an improved lubrication system for a punching or forming assembly adapted for use in punch press tooling including automated thick turret punch press tooling.

### BACKGROUND OF THE INVENTION

Punch failure has several causes, the main factors being excess heat, fracture and galling. Excessive heat will anneal the punch point and tend to soften it. This contributes to an easier breakdown of the edge. Investigations carried out in developing the present invention also show that the lubrication does not consistently cover the punch point. If provided consistently, the lubrication reduces heat buildup and can extend the life of a punch point. Punch fracture is a condition in which metal chips away from the cutting edge of the punch. Lubrication will help this mode of failure but only minimally. Galling is a condition in which the punch point collects material being punched or formed. As material is punched, the punch point heats up which may cause the material to stick to the sides of the punch point. This condition creates multiple problems such as for example hole size enlargement and hole quality deterioration as well as stripping issues (the tendency for the punch point to stick in the workpiece). Traditional lubrication is inconsistent. Performance which may require cycle counts of 1000 strokes per minute (16 strokes per second) therefore suffers under certain conditions.

While various lubrication systems have been previously proposed for use in metal processing equipment, there is a need for improved lubrication especially in the case of a high-speed punching or forming assembly that is to be used with turret style CNC punch presses. High operating speeds and increased use of standard tooling have created an increasing demand for improved lubrication in punching or forming assemblies that are mounted in the turret press. Prior lubrication has often been a hit-or-miss proposition. This contributes to premature damage and often requires the replacement of parts, especially the punches, dies and an associated stripper which is used to help remove the workpiece from the punch point. For example, in U.S. Pat. No. 5,056,392, the punch depends upon receiving oil that flows downwardly from the punch press ram above the punch assembly into an annular lubrication trough which communicates with the radially extending run-off slots allowing lubricant to flow down the outer surface of a sleeve to provide lubrication between the punch assembly and the turret bore. However, in actual production runs there are frequently times when lubrication is interrupted or when lubricant application is provided in certain patches and not in other places where the moving surfaces are in sliding contact, much less a way to apply lubricant uniformly or prevent a serious buildup of heat in certain locations. U.S. Pat. No. 2,320,862 shows a method of making tubular rivets in which a lubricant is provided in a container separate from the punch and a U-shaped absorbent member which may be used to lubricate a punch. The lubricator, however, is on the end of an arm which must be brought into position to lubricate the punch before each stroke and then must be moved out of the way; an operation that requires far too much time to be of commercial use in the present application. Various kinds of lubricators have also been provided in other industries. For example, U.S. Pat. No. 4,196,944 describes a lubricator using a wick for lubricating the ball bearings of a molding die support. Ball bearings are however typically unsuited for punching and forming equipment. Moreover, the wicks disclosed are both inaccessible and unsuited for rapid removal and replacement nor adapted to hold lubricant in contact with a moving punch point. U.S. Pat. No. 5,178,233 shows that it is possible to use a folded piece of felt in an externally exposed position on the top surface of a punch guide used for punching soft metal sheets, such as aluminum. This arrangement is unsuitable for the purposes of the present invention, in part because it is essential to be able to punch a wide variety of hard metals, such as galvanized iron and stainless steel while cycling continuously at say, 1000 cycles per minute without losing the lubricant as well as a requirement for the punch assembly to hold the lubricant during continuous long-duration press runs. U.S. Pat. No. 6,622,601 teaches the placement of a felt member in an open fully exposed location on top of a guide forming the top of the workpiece passage. Lubricant in an exposed position is unsuitable for high speed automated punching as performed for example with what is known as a thick turret press as well as other high-speed punching and forming assemblies used in turret or CNC presses with which the applicant is concerned wherein the workpiece is placed between a pair of vertically spaced apart circular turrets that rotate during operation to place successive punch assemblies at a fixed workstation. If U.S. Pat. No. 6,622,601 were applied to a turret-style press, operation would be unsuccessful since different punch assemblies would then somehow need to be placed in succession above the location where the patented felt member is exposed above the workpiece passage.

### SUMMARY OF THE INVENTION

Modern high-speed forming or punching presses commonly provide a rotating turret that may support a dozen or more removable punch assemblies of different kinds distributed on its periphery which are brought successively to a fixed punching station for punching or forming a workpiece. These punch assemblies are stored in racks close to the punch press so that they can be mounted conveniently for operation on the upper turret of the punch press as required. Each removable punch assembly comprises a unitary mechanism including an outer casing in which the punch is slidably mounted usually with a spring or other resilient element for retracting the punch after it has been struck during a punching cycle by a ram of the punch press. Heretofore, no satisfactory system has been provided for lubricating or retaining lubricant within the casing of such a punch assembly.

In accordance with the present invention, a punch element is mounted in the usual way for sliding movement in the guide sleeve or casing with the punch point at its lower end for forming or punching a workpiece. A stripper element is located at the lower end of the guide sleeve which defines the casing of the punch assembly, and the stripper element has an opening aligned with the punch tip through which the punch point passes to engage the workpiece. In accordance with the invention, a matrix placement chamber is provided within the casing between the punch point and the guide sleeve so as to at least partially surround the punch point and at least one flexible lubrication matrix body is contained in the matrix placement chamber inside the housing. The matrix is enclosed entirely within the casing of the unitary punch assembly in which the punch reciprocates. The lubrication matrix comprises an integral porous elastic multi-cellular polymeric body containing a multiplicity of hollow communicating cells adapted to hold a lubricant in fluid communication with the sidewalls of at least the point of the punch and in a preferred form completely surrounds the punch point. The lubrication matrix can also hold an abrasive in particulate form either with or without a lubricant, and in a preferred form the matrix has a passage through it that is in sliding contact with the punch point inside the housing so that the matrix performs a wiping motion along the side surface of the punch so as to distribute lubricant over the punch point as the punch reciprocates in the guide sleeve. The elasticity of the matrix is used in a preferred form to draw this matrix into physical contact with the punch and to press against its outer surface during a punch or forming operation. The improvements provided by the inventors are particularly important because once a punch starts to wear, many of the adverse conditions noted above progress rapidly causing punch deterioration and failure.

It is therefore an important objective of the invention to keep wear of parts in check from the beginning to thereby insure the life of the punch or forming tool.

Another object is to reduce or prevent a stripping problem in punching or forming operations.

An additional object is to eliminate the need to add lubrication to the bottom or top of a metal sheet or other workpiece.

A still further object is to help keep debris from building up on the punch point, to create better and more consistent punch forms, to improve hole quality, to extend punch life at a relatively low cost and to prevent debris from entering the system.

Other objects, advantages and novel features of the invention will become apparent from the following description of the preferred embodiments when considered in conjunction with the accompanying drawings.

### BRIEF DESCRIPTION OF THE DRAWINGS

FIG. 1 is a diagrammatic perspective view of a punch press in which is mounted several punch assemblies in accordance with the invention, each with a die aligned beneath it on the lower turret.

FIG. 1A is a partial vertical sectional view of the upper and lower turrets shown in FIG. 1 on a large scale in which a punch assembly in accordance with the invention is mounted for operation.

FIG. 1B is a perspective view of assorted preformed matrix blanks.

FIG. 2 is an enlarged view of FIG. 1A showing the punch as positioned just before being struck by the ram of the punch press.

FIG. 3 is a partial view of the lower end of FIG. 2 showing the punch positioned as an opening is being formed in a workpiece.

FIG. 4 is a modified form of the invention showing another form of punch and guide sleeve punch in the same operating position as shown in FIG. 3.

FIGS. 5A-5C show successive steps of forming a lubrication matrix in accordance with the method of the present invention.

FIG. 5D shows a lubrication matrix formed as in FIGS. 5A-5C in which a central opening of irregular star-shaped cross sections are formed in accordance with the method of the present invention.

FIG. 6 is a partial exploded perspective view of FIGS. 1-3 on a smaller scale showing an upper and a lower matrix as it is being inserted into the punch guide sleeve.

FIG. 7 is a view similar to FIG. 3 of a modified form of the invention having three punch points.

FIG. 8 is a partial vertical sectional view of a forming assembly in accordance with another form of the invention.

FIG. 9 is a tapping punch in accordance with the present invention.

FIG. 10 is a graph showing the effect of pore size on matrix performance and punch lubricator characteristics.

FIG. 11 is a micrograph showing a small section of matrix enlarged four hundred percent.

### DESCRIPTION OF THE PREFERRED EMBODIMENTS

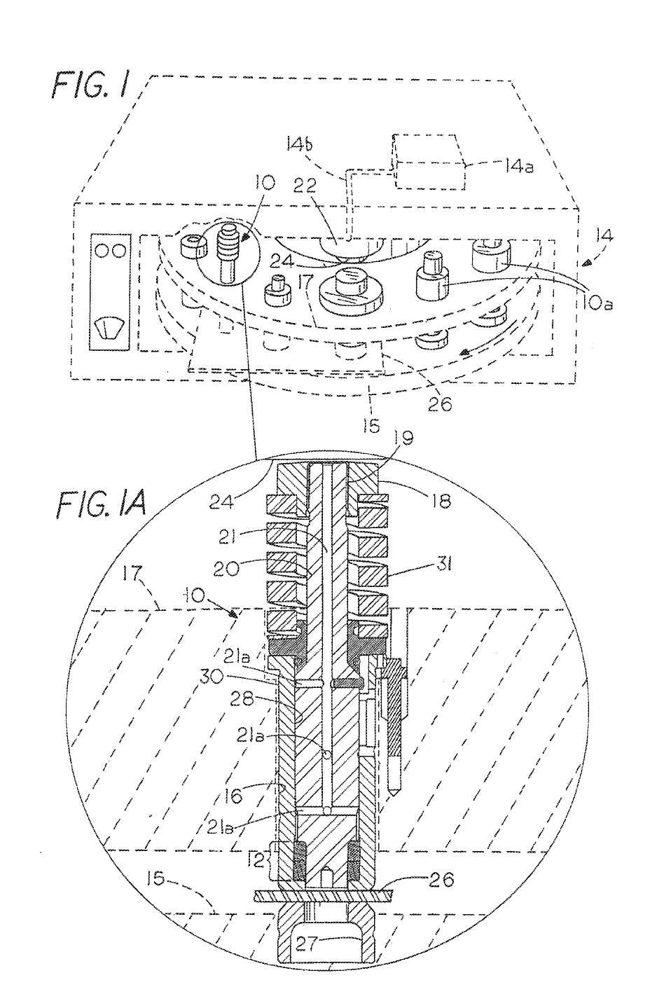

Refer to figures wherein the same numerals refer to corresponding parts in the several views and especially to FIGS. 1-3 which illustrate a punch assembly 10 including a lubrication matrix 12 in accordance with the invention. The punch assembly 10 which is mounted in an electronic or a computer numerically controlled (CNC) punch press 14 such as that known as a thick turret punch press of suitable commercially-available construction along with several other punch assemblies 10a also in accordance with the invention which are each placed in an opening such as 16 in the upper turret of the punch press 14. The punch assembly 10 includes a hardened punch head 18 screw threaded at 19 to the upper end of an elongated punch 20 with the punch head 18 positioned during operation at a workstation indicated generally at 22 in vertical alignment beneath a punch press ram 24. In operation, the upper turret 17 and the lower turret 15 are rotated under an electronically programmed sequence to place the several punch assemblies 10 or 10a successively in position at the workstation 22 beneath the ram 24 for punching or forming a workpiece 26. A die 27 aligned with punch 20 is supported on the lower press turret 15 below workpiece 26. The punch 20 as can be seen in the figures is mounted for sliding movement within the central bore 28 of a guide sleeve 30 which defines a casing or housing for the punch assembly 10.

Operatively associated between the head 18 and the upper end of the guide sleeve 30 is a helical compression spring 31 which is secured to the upper end of the guide sleeve 30 by an adapter 34 or other suitable connecting element. It will be seen that the punch 20 has a shaft portion 20a with an outer sidewall that is in sliding contact with the inner bore 28 of the guide sleeve 30. However, at the lower end of the shaft portion 20a is the punch point 20b which has a reduced diameter defining an annular punch placement chamber 32 between the guide sleeve and the punch point 20b. Contained in chamber 32 is a lubrication matrix bodies 12, which in this case is made up of two pieces, an upper matrix body 12a and a lower matrix body 12b. As can best be seen in FIG. 6, the upper and lower lubrication matrix components each comprise an annular body having an outer cylindrical sidewall with an upright central passage of the same or slightly smaller cross section as the punch point 20b with the inner surface of both matrix bodies 12a and 12b positioned in sliding contact with the punch point so that each matrix performs a wiping motion along the side surface of the point as the punch reciprocates in the guide sleeve 30 during operation. By reference to FIGS. 1A-3, it will be seen that by providing a punch point 20b having a cross section smaller than the punch 20, a downwardly facing shoulder 23 is formed which during operation engages the top surface of the matrix body forcing it downwardly so as to compress it for the purpose of dispensing lubricant or other liquid onto the outer surface of the punch point which is in contact with the matrix 12.

The matrix 12 can consist of a single body or multiple bodies, preferably but not necessarily saturated with a liquid, a lubricant or a cleaning liquid. The matrix bodies are supplied in stock size sheets, such as 1, 2 or 3 in. outside diameter sheets of any desired thickness as shown in FIG. 1B and can be provided with a circular, rectangular or irregularly-shaped outline as required.

If the punch point or punch forming insert is small, such as under ¼ in. O.D., the matrix body can be pushed onto it manually so as to create an upright opening for the punch point as the body is being pressed onto and slid up on the punch point. However, if the punch point or workpiece forming insert is of a significantly larger size, a hole or starter hole will need to be cut into the matrix body to facilitate mounting the matrix on the punch point or other forming unit.

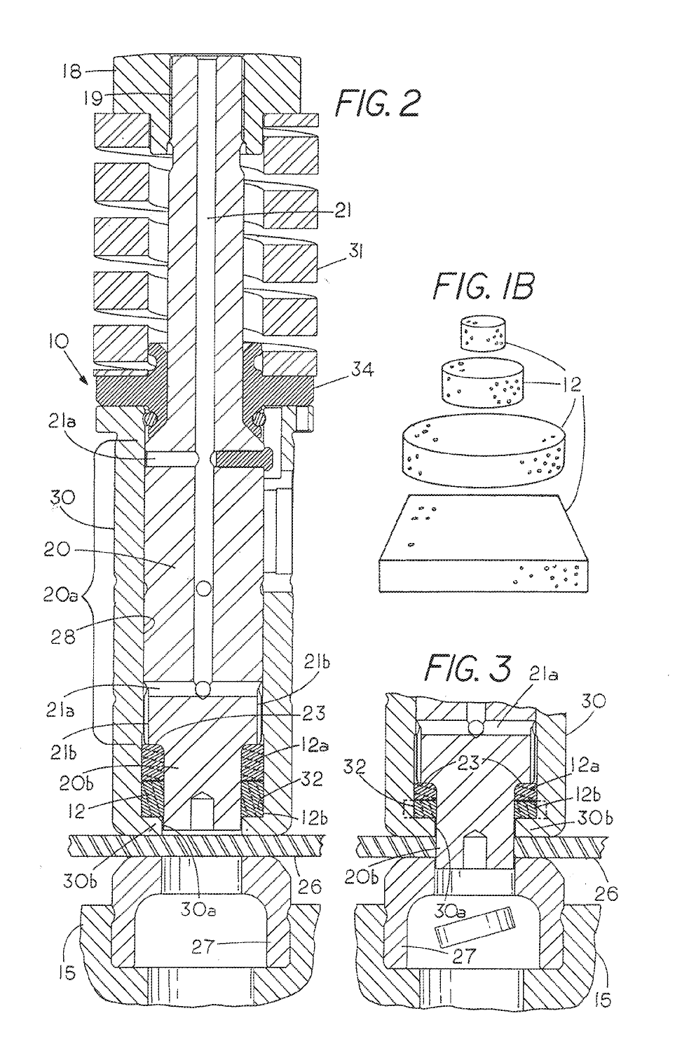

At the lower end of the guide sleeve 30 is an opening 30a that is smaller than the inside diameter of the guide sleeve just below the chamber 32 so as to define a lower wall 30b surrounding the opening 30a which serves as a stripper to enclose the matrix 12 on all sides and help strip the punch point 20b out of the workpiece after a hole has been formed (FIG. 3).

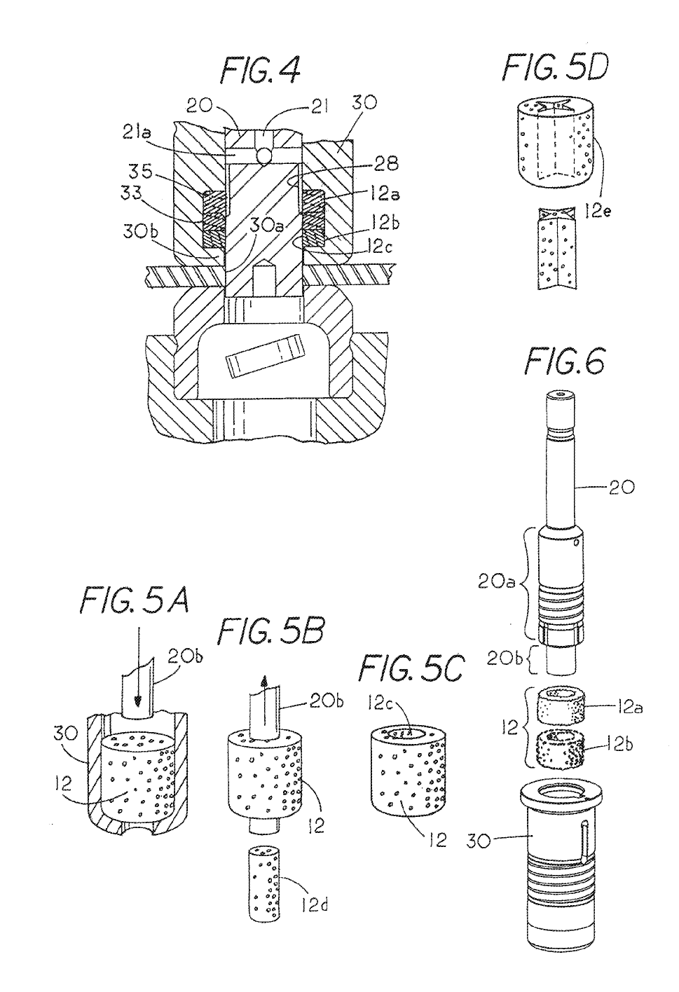

The method of forming the matrix bodies according to the invention is shown in FIGS. 5A-5C and FIG. 6. According to this method, one of the stock matrix bodies 12 of FIG. 1B is placed in the guide sleeve 30 (FIG. 5A). These preformed matrix bodies 12 are preferably supplied in the form of sheets in disk form in assorted sizes to fit stock punch assemblies. Next, the punch 20 is placed in the guide sleeve 30 and the punch point 20b is then driven through the matrix body 12 as shown in FIG. 5B causing the core 12d of the matrix body to be cut out and removed to provide a central passage 12c (FIG. 5C) by using the stripper opening 30a as a cutting instrument. This can be done either manually or with the aid of a hand tool, such as a hammer, or by using the punch ram 24. The core piece 12d is removed and discarded. By forming matrix bodies in this manner, it was found that the inner wall of the matrix will hold fluid, such as a lubricant or a cleaning liquid, in fluid transmission communication with the sidewall of the punch point 20b and will serve to continually wipe lubricant or other liquids across the surface of the punch point which is in sliding contact with the inside of the central passage 12c within the matrix body 12. FIG. 5D illustrates how by using this method it is possible to accurately form complex shapes with irregular intersecting sidewall surfaces such as the star configuration shown in FIG. 5D and all of these surfaces will be adequately lubricated by the inner confronting surface of the matrix body 12e, thus spreading the lubricant uniformly over all surfaces of the punch point during each cycle of operation.

Lubricant can be preloaded into each matrix body before assembly or supplied from the lubricant supply tank 14a through the conduit 14b into an opening in the ram 24 and then enter the punch through passage 21. When lubricant is added in this manner, it is able to flow downwardly over the outer surface of the punch and is then absorbed into the matrix 12. From the lubricant supply tank 14a of FIG. 1, lubricant is conveyed to the punch ram through a pipe or other duct 14b to the workstation 22 either by gravity or by means of a pump (not shown) then fed through the center of the ram 24 to an oil supply duct 21 that runs through the center of the punch 20 and which is provided with laterally extending ports 21a that may communicate through longitudinally extending grooves 21b on the outer surface of the punch with the matrix placement chamber 32. Once the matrix is loaded with a lubricant, the punch point will be in direct contact with the lubricant and matrix interface against the sidewall of the punch tip where, owing to the resiliency of the matrix, the lubricant is spread along the surface of the punch point with a wiping action at the punch reciprocation. When the punch point is in the rest position, the punch point is fully inside the punch assembly and in contact with the lubrication matrix 12. During the punching or forming process, the matrix is compressed as noted above so that some lubrication may be dispensed or bled out of the matrix onto the punch point and then will flow into the gap between the stripper and workpiece as well as the sides and tip of the punch point. When the punch point is retracted, excess lubricant is reabsorbed by the matrix.

The matrix bodies when saturated with lubricant or cleaning fluid will keep the fluid in close contact with the sidewall of the points, forming inserts or taps. They also act as dispensers for the stored fluid when the tools are cycled and the matrix bodies are compressed. This action is successful due to the absorbent properties of the matrix bodies, their ability to retain fluid and also their ability to expand to a relaxed, uncompressed state after being compressed. It was found that the application of lubricant to the punching surfaces by means of matrix bodies that are entirely enclosed within the guide sleeve 30 which form the casing of the punch assembly greatly reduces galling (adhesion of material from the workpiece 26 to the punch point 20b) which we have now found greatly extends the life of the punching, forming or tapping tool. The lubrication also reduces friction which in turn reduces the heat build-up and the force required for stripping the punch point from the workpiece.

The invention is suitable for a single station punch, i.e., a punch assembly as shown in FIGS. 1-3 in which a single punch is located within the housing defined by the guide sleeve 30 as well as a multi-hole (cluster) punching or forming unit or what is known as a mu)ti-tool or a thread tapping tool. Thus, the invention is both suited for use in virtually any punching or forming assembly in which a punch is slidably mounted within a guide sleeve and placed in a punch press for operation to punch or form a workpiece.

In one preferred form of the invention which can be seen by reference to FIG. 6, a pair of matrix bodies is used in which the upper body 12a is filled with a lubricant and the lower body 12b is filled with a cleaning solution so that during operation, the punch point and associated components are cleaned and lubricated during every stroke of the machine and every cycle of the tool as the matrix bodies provide fluid to the surfaces of the tool.

The invention was also found to provide a significant reduction in heat buildup that normally occurs in long production runs for punching, tapping or forming. This results from the ability of the matrix body or bodies to absorb the heat and to transfer it to the surrounding components as well as by reducing heat by lowering the friction between the sliding surfaces in contact with one another. Cooler operating temperatures help make the tools last longer and also were found to make the tool less susceptible to becoming brittle or fracturing. It was found that the matrix bodies are able to hold enough fluid to greatly reduce or eliminate the need to periodically add more lubrication to the surface of the workpiece being processed. This in turn helps to reduce the time and effort required to clean the material for downstream processing, such as painting, coating, etc.

It was also found that an oil supply tank 14a provided on the punch press 14 can be used in supplying lubricant to matrix bodies in accordance with the invention and will provide lubrication efficiently with less lubricant by absorbing and holding the lubricant within the guide sleeve instead of being allowed to run through the tool and onto the die. It will also distribute the lubricant around the punch point in a more reliable and controlled fashion during each punching, forming or tapping cycle. It was found that the matrix bodies tend to form a seal that will function to keep debris created during the punching, forming or tapping operation from entering the tool and causing damage. This is important since a punching environment is notoriously dirty. Keeping the dirt and other debris out of the internal components of the tool will greatly improve the life of the whole tool system and its components. The matrix bodies 12 can also be removed, cleaned, relubricated and reinstalled as required.

Each of the preferred matrix bodies are formed from an integral porous elastic multi-cellular polymeric body composed of a suitable plastic resin containing a multiplicity of hollow communicating cells, each adapted to hold a lubricant or other liquid in fluid communication with the sidewalls of at least a punch point portion of the punch 20. Any of various plastic resins or synthetic rubber can be employed, such as polyethylene, polyurethane, polypropylene, polyester, polytetrafluoroethylene or polyether. Polyether is one of the preferred matrix polymers. One suitable matrix body is an open celled polyether foam sheet material PDQZ80 that is sold by the Foamex Company of Eddystone, Pa. If desired, a commercially available rubber O-ring formed from an oil-resistant elastomer (not shown) can be placed over the punch point below the matrix 12 to reduce or control the flow of lubricant into the opening 30a between the punch point and the lower end of the guide sleeve. As shown in FIG. 3, the chambers 32 can if desired be provided with one or more inwardly opening pockets that have no matrix in them and extend outwardly from the matrix placement chamber 32 indicated by dotted lines which serve as lubricant reservoirs for storing excess lubricant squeezed out of the matrix body as the punch 20 reciprocates and then sucked back in as the matrix expands between strokes or between production runs.

Refer now to FIG. 4 which shows a modified form of the invention, although not a preferred form in which the punch 20 has a uniform cross-sectional width throughout, i.e., the same diameter from top to bottom in sliding contact with a bore 28 in the guide sleeve 30. In this form, the guide sleeve is provided with an enlarged inside diameter at 33 defining a matrix body placement chamber 35 containing the matrix bodies 12a and 12b in vertical alignment and in contact with the sidewall of the punch 20. In this case however the matrix bodies will not be deflected or compressed by the movement of the punch 20 which instead merely slides through the central opening 12c of the matrix in contact with its inner surface. Consequently, neither the matrix nor the liquid lubricant or other material contained in the matrix is agitated, compressed or otherwise moved significantly during operation. The lubricant therefore tends to remain quiescent and is not distributed in a vigorous manner as in the case of FIGS. 1-3 while the punch reciprocates during operation. This form of the invention is not a preferred form and does not perform as well as primarily because the matrix placement chamber 35 is more difficult to form during manufacture, the lubricant moves less and the matrix is more difficult and time consuming to insert into the placement chamber.

Each time a matrix body is compressed by the punch, there is a tendency for lubricant to be squeezed out and that way expelled onto the surface of the tool so as to insure uniform lubrication around the interface between the tool and stripper as well as the workpiece.

Two separate contacting matrix bodies are shown in FIGS. 1-3 and 6. It can be seen that the lower matrix 12b of FIG. 6 is of a more coarse construction with larger pores than the upper matrix 12a. The use of two matrix bodies together in stacked configuration is able to take advantage of differences in firmness and lubricant retention capability. Thus if one is more firm (having a greater resistance to compression) and a smaller cell structure (higher PPI) than the other matrix, it can be used as a storage reservoir for lubricant that is squeezed from the adjoining matrix which is less firm and is therefore compressed to a smaller volume than the other matrix. In this way, it is possible to store lubricant in one matrix that was squeezed from the other and thus keep more of the lubricant in contact with the moving parts instead of running out of the equipment and being lost. For example, matrix 12a can be provided with a PPI of 80 and matrix 12b a PPI of 40. In selecting cooperating pairs of matrix bodies that are used in contact with one another, their compressibility differentials can be checked by applying pressure to the stacked matrix bodies and measuring the relative compression height of each. The storage of lubricant in one of the matrix bodies is especially valuable when there is a need to avoid having to apply lubricant to the workpiece, for example, sheet metal that most be moved by using suction cups.

The presence of one or more abrasives in particulate form distributed through the matrix is used to hone, polish or burnish the punch point. Any suitable abrasive in powdered form, such as aluminum oxide or silica, can be used with or without lubricant. During operation, minute flakes of metal removed from the surface of the workpiece which might otherwise adhere to the punch point are then scraped from the surface of the tool by the abrasive particles and held within the matrix body for convenient removal when the matrix body is cleaned or replaced.

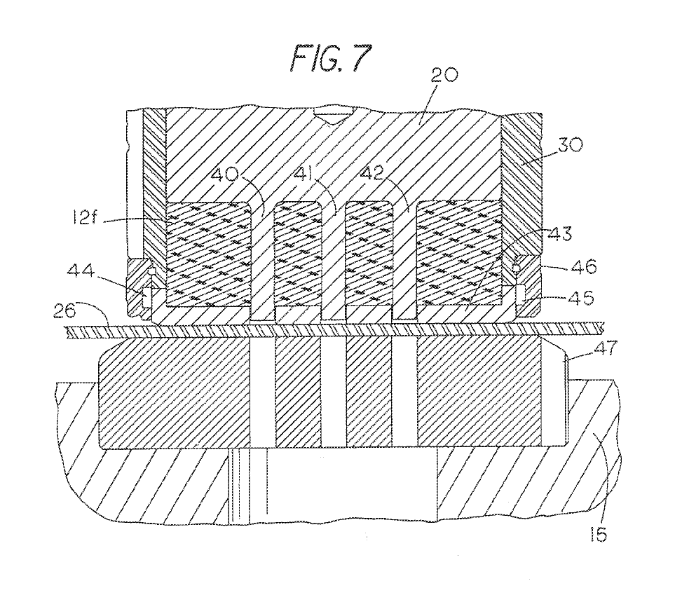

Refer now to FIG. 7. In this form of the invention, the punch is provided with three punch points (40, 41 and 42) which extend through corresponding openings in a single matrix body 12f. Since the punch points 40-42 are relatively small in size, the openings in the matrix body 12f are formed by placing the matrix at the lower end of the guide sleeve 30 and then manually forcing the punch points through the matrix material to form the openings before the punch assembly is used. In this embodiment, the stripper comprises a removable stripper cap element 43 having lugs that extend laterally at 44 and 45 and are held in place by a retaining ring 46 that can be rotated by the operator to enable the stripper cap 43 to be removed when desired so that the matrix body 12f can be examined, cleaned and reused or replaced as desired. Below the workpiece 26 is a suitable die 47 of well known construction that is supported in the lower turret 15 conventionally.

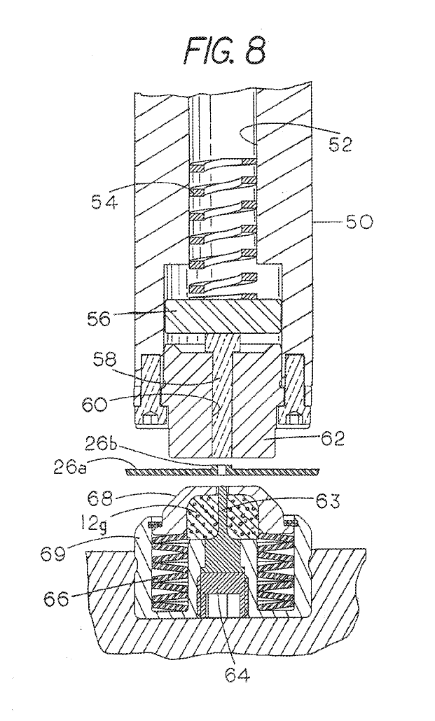

Refer now to FIG. 8 which illustrates the application of the invention as a forming tool. In this embodiment, in place of the guide sleeve 30 there is mounted in the upper punch press turret 17 a cylindrical casing 50 having a center bore 52 containing a helical compression spring 54 exerting downward pressure against a spacer 56 which is in contact with the upper end of a spring-loaded pin 58 that is slidably mounted in bore 60 of a forming tool 62 which is placed during operation against the upper surface of the workpiece 26a. The casing 50 is held securely in the upper turret 17 during operation. Below the workpiece is a cylindrical forming tool 63 supported securely on an abutment 64 that is centered within an annular Bellville compression spring assembly 66. The forming tool 63 has an upper forming point portion that extends through an opening in the upper end of the stripper 68 which is itself yieldably biased upwardly by the bellville spring assembly 66 so that when the forming head 62 and tool 63 are brought together on opposite sides of the workpiece, the tool 63 will deflect the workpiece around an opening to form an upwardly turned annular flange 26b by forcing material upwardly into the bore 60 supporting the spring-loaded pin 58 which rises slightly to accommodate the flange 26b. Mounted within the stripper 68 around the forming tool 63 is a flexible annular matrix body 12g which is compressed slightly within the compartment inside the stripper 68 as the stripper 68 and workpiece are forced downwardly against the upward pressure of the spring 66, in effect causing the point of the forming tool 63 to rise out through the top of the cover 68 and into the opening in the workpiece as it slides upwardly through the matrix body 12g which can be filled with any of the previously described lubricating, cleaning or abrasive agents which will then be spread onto the surface of the forming point 63 with a wiping action during the forming operation.

In FIG. 8, the stripper 68 removes the workpiece from the forming tool 63 and the die body shown at 69.

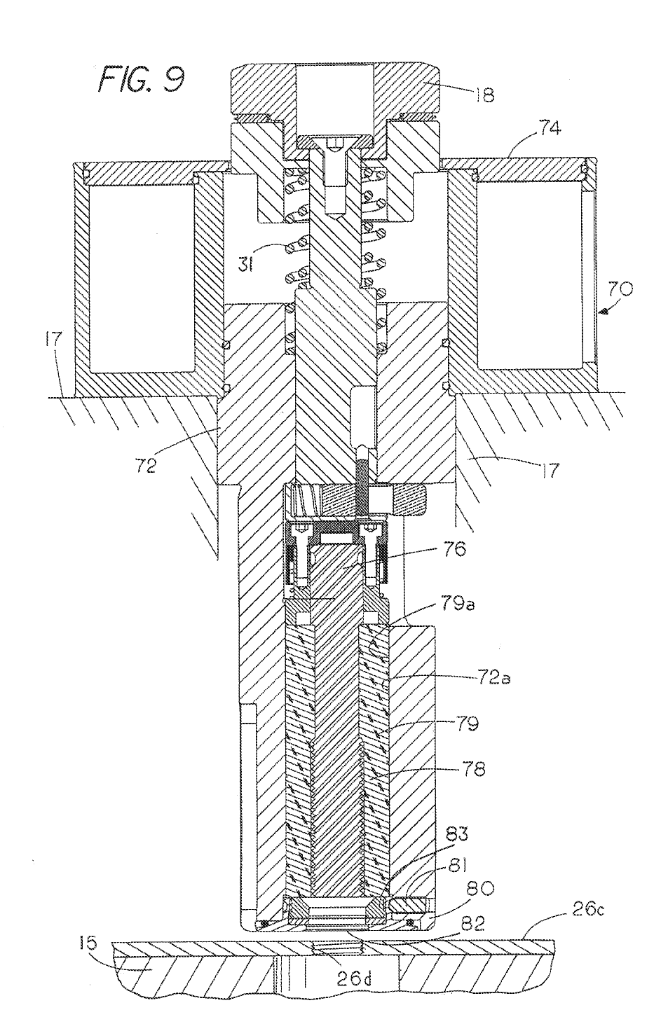

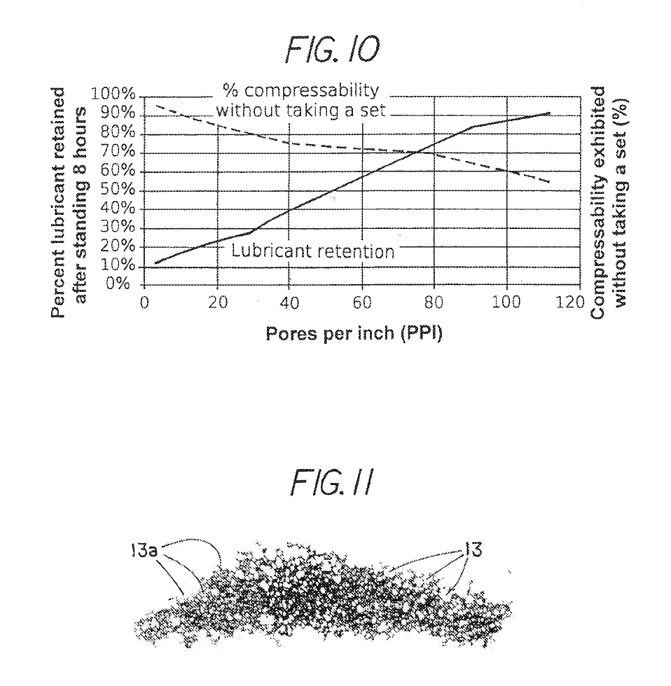

Refer now to FIG. 9 which illustrates how the invention is applied to a punching and tapping tool indicated generally at 70 which is of any suitable known construction. In this case the forming and tapping tool 70 includes a cylindrical upright casing 72 surrounded at its upper end by an annular housing 74 that enables the entire casing 72 to rotate about a vertical central axis. Held rigidly within a central longitudinal bore 72a is a tap 76 which is spaced inwardly from the bore to define a matrix placement chamber 78 that extends almost to the bottom of the casing 72. At the bottom of the casing is secured a stripper 80 having a central opening 82 through which the tap 76 extends during operation to provide a threaded opening 26d in a workpiece 26c supported on the upper surface of the lower turret 15. A key 81 is engaged between the stripper to hold a ferrule 83 in place above the opening 82. The forming and tapping tool 70 can be generally of any suitable well-known commercially available construction, with the addition of a matrix placement chamber 78 between the casing 72 and the tap 76. Inserted within the chamber 78 is an annular matrix body 79 in accordance with the invention having an axial passage 79a which surrounds and contacts the outer surface of the tap 76. In operation as the casing 72 is rotated within the turret, the ram 24 is driven downwardly at a coordinated speed causing the tap 76 to be forced out through the lower end of the stripper 80 and through the workpiece 26c so as to provide the threaded opening 26d. As the tap rotates, much of the metal cuttings and debris that would otherwise adhere to the tap are removed from the tap as it is retracted out of the workpiece by the matrix body 79 thereby cleaning the tap and preparing it for the next operation. As described above, the matrix can be prefilled or filled periodically with lubricant or a cleaning solution which is retained within the cells of the matrix throughout operation.

Lubrication retention capability refers to the ability of the matrix body to retain lubrication while at rest. Over time, the lubrication tends to drain out due to gravity alone. As the number of pores per inch (PPI) is increased, the ability to retain the lubrication media is increased, thus enabling the matrix to retain lubrication for extended periods of time. It was found that once the initial loss occurs very little additional lubricant is lost over time. Another benefit of the increased matrix PPI is an improvement in storage capability. However, in developing the present invention, it was found that there is an adverse effect of an excessive PPI, i.e., small size cells. When the PPI is increased beyond a preferred range, the density of the matrix increases. As a result, it is possible for there to be more polymeric matrix substance than pores and as this trend is increased, the amount that the foam can be compressed becomes limited. Since the matrix is placed in a confined space in which compression can occur, it was discovered that it is beneficial to allow for a substantial compression ratio.

It was also found important to provide a large enough PPI, i.e., smaller size pores, to be able to retain the lubrication, even though this tends to reduce the lubrication absorption rate. Thus, lubrication retention capacity tends to be inversely proportional to the rate or speed that the matrix is able to re-absorb lubrication. Since cycle times are quite high (generally 1-5 per second), it is important for the matrix to respond quickly.

Refer now to FIG. 10, which shows graphically the effect of matrix pore size on performance. In the development of the present invention, the applicants found that the three most significant interrelated factors in determining and predicting the performance of a matrix body in punching and forming equipment are the matrix pore size, the ability of the matrix body to be compressed without taking a set and lubricant retention during use. As the punch reciprocates, a certain amount of the original lubricant dispersed in the pores of the matrix is expelled. The remainder is retained and available for application to the surface of the reciprocating punch tip. FIG. 10 shows how as the number of pores per inch (PPI) increases in the range of about 5 PPI to 110 PPI, the lubricant retention increases dramatically from only about 10% to around 90%. However, the graph also shows that as the PPI increases, the useful compressibility, i.e., compressibility which can be performed without causing the matrix to take a permanent set, drops from somewhat over 90% to about 55% when the PPI reaches 110. Thus in accordance with the invention, a preferred pore size is generally in the range of about 40-110 PPI but preferably in the range of about 60-100 PPI with an optimum of about 70-90 PPI. It was also found that the greater the PPI, the thinner the viscosity of the lubricant that may be used and the more open the cell structure, the greater the viscosity required to insure that the lubricant is retained. Consequently, it is not an advantage to have a PPI at the extreme end of the range shown in the graph (FIG. 10). It should be understood that the performance shown in FIG. 10 is based on a typical lubrication viscosity in the range of about 10-30 saybolt seconds. However, as the viscosity of the lubricant increases, the PPI required to perform well is reduced. Inversely, if the viscosity decreases, a higher PPI may be used. While performance depends upon a number of variables, outstanding results have been achieved with a PPI of around 75-85. However, considering variations in viscosity as well as the relative size of the matrix compared with the size of the matrix placement chamber, a useful working range of about 60-100 PPI was found to be suitable for most applications.

The structure of the matrix body will now be described in more detail with particular reference to the micrograph of FIG. 11 at a magnification of 400%. It can be seen that the matrix comprises an integral porous multi-cellular polymeric body which contains a multiplicity of hollow communicating cells 13 that are adapted to hold a lubricant but which can also hold cleaning liquid such as mineral spirits or xylol or suitable liquid hydrocarbon used for cleaning. The polymeric wall structure between the cells 13 is designated 13a.

The invention provides several advances in improving the quality of a punching or forming operation. The matrix is able to retain lubricant over extended periods of time even though fitted into a confined space and subjected to fast hit rates that may reach a thousand strokes per minute or more while decreasing tool friction and lowering operating temperature. Moreover, the matrix can be compressed in some cases to 70% of its original volume, e.g., from 1 in.³ to 0.7 in.³and yet will return to its original volume after repeated compressions while applying lubricant to the punch over extended periods of time.

The invention also provides a quick method of cutting and sizing the matrix using the punch point and stripper to cut the opening defining the inside diameter of a passage through which the punch point passes during operation and thus provides a cut internal surface that is able to contact the punch point on all sides. This is particularly important in the case of irregular punch shapes, such as a star-shaped punch, etc. The invention also helps to prevent debris from entering the guide body by filling a gap between the stripper and the punch point. Moreover, the invention provides a low cost lubrication method which is easily installed and serviced, renewed and makes possible a more efficient use retention of lubrication and with less mess on or around the punch point. It was also found that lubrication continues during long production runs.

This invention will be better understood by reference to the following additional examples:

### EXAMPLE 1

### Baseline (Without Matrix or Lubrication)

The punching system generally as shown in FIGS. 2 and 3 and having a punch with a diameter of 0.156″ and a die with 0.012″ clearance was used to punch 0.125″ thick 2024 T3 Aluminum sheet at speeds of 250 to 300 hits per minute with no matrix or lubrication present in the punch to material interface. Punch point galling started after 50 hits followed by punch failure before 1,050 hits. Failure was considered to constitute a growth of the punch point to +0.002 inch larger than the start diameter of 0.156″.

### EXAMPLE 2

### Invention

A matrix of polyether foam produced by the Foamex Co. of Eddystone, Pa. with an open cell structure having 80 pores per inch, 1.35″ in diameter and 0.8″ thick with a 1.15 cubic inch volume was placed over the punch point of Example 1 and saturated with 4.5 cc of Mobil DTE-25 hydraulic fluid. The punch assembly as in FIGS. 1-3 having a punch point diameter of 0.156″, a die with 0.012″ clearance was used to punch 0.125″ thick 2024 T3 Aluminum sheet at speeds of 250 to 300 hits per minute while compressing the matrix 50% to a height of 0.400″. The punch point was evaluated for galling after every 525 hits with absolutely no signs galling following the completion of the test at 6800 hits. In comparison to Example 1, the punch was projected to last a minimum of 6.5 times longer. This was based on a calculated product failure at 6800 hits. In reality no signs of galling were found to be present after 6800 hits so the life could theoretically be expected to be infinite as long as the punch point continued to stay in contact with the lubrication saturated matrix. Inspection of the matrix after testing revealed no signs of degradation and it was noted that sufficient lubrication remained in contact with the matrix and the punch point.

Many variations of the invention within the scope of the appended claims will be apparent to those skilled in the art once the principles described herein have been read and understood.

1. A punch and die assembly for use in a punch press having an opening for holding the punch assembly, said punch assembly comprising,
a guide sleeve adapted to be mounted on the punch press;
a punch mounted for sliding movement in the guide sleeve and having a punch point at a lower end thereof for forming or punching a workpiece;
a stripper element located at the lower end of the guide sleeve that has at least one stripper opening aligned with a punch point to enable the punch point to pass therethrough for engagement with a workpiece,
the punch assembly having a matrix placement chamber between the punch point and the guide sleeve which at least partially surrounds the punch point; and
at least one flexible matrix contained in the matrix placement chamber, said matrix comprising a porous elastic multi-cellular polymeric body containing a multiplicity of hollow communicating cells that are adapted to hold a lubricant in fluid communication with the sidewalls of at least the punch point.

2. The punch and die assembly of claim 1 wherein the matrix has an opening that is in sliding contact with the punch point such that the matrix performs a wiping motion along a side surface of the punch that spreads a lubricant thereon as the punch reciprocates in the guide sleeve.

3. The assembly of claim 1 including a lubricant or at least one cleaning agent dispersed within the cells of the matrix.

4. The assembly of claim 1 wherein an abrasive in particulate form is dispersed within the matrix for honing, polishing or burnishing the punch.

5. The assembly of claim 1 wherein the punch comprises a shaft portion of a selected width and a punch point of a reduced width that is less than the width of the shaft,
the matrix placement chamber comprises a compartment located laterally of the punch point that has a top wall comprising a lower end of the shaft portion of the punch above the compartment and
wherein the punch is adapted to engage and to apply pressure to the matrix to thereby compress the matrix during a punching or forming operation.

6. The assembly of claim 1 wherein the guide sleeve has an inner passage of a selected width adapted to be slidably engaged with the punch and also includes an enlargement in the width of the passage that is larger than the width of the punch point to thereby form a compartment which defines the matrix placement chamber for holding the matrix therein.

7. A matrix for use in a punch and die assembly that has a guide sleeve containing a punch which is adapted to form or punch a workpiece, the matrix comprising,
at least one piece of flexible matrix material comprising porous multi-celled polymeric body containing a multiplicity of hollow communicating cells surrounded by cell walls that are integral with one another, the hollow cells being adapted to hold a lubricant therein in fluid communication with at least a sidewall portion of the punch as a part of said punch assembly.

8. The matrix of claim 7 wherein a lubricant is dispersed within the cells of the matrix for lubricating the punch point.

9. The matrix of claim 7 wherein an abrasive in particulate form is dispersed within the matrix for honing, polishing or burnishing the punch.

10. The matrix of claim 7 wherein the matrix has at least one opening therethrough to receive the punch when the punch is positioned within the guide sleeve and the punch has a downwardly facing wall portion engaging a top surface of the matrix to apply pressure during operation to an upper surface of the matrix to thereby compress the matrix for expelling a material from the matrix as the punch reciprocates within the guide sleeve.

11. The punch and die assembly of claim 1 wherein the chamber has a side wall that encloses the matrix on all sides.

12. The punch and die assembly of claim 1 wherein the punch has threads thereon so as to thereby comprise a tap for threading a workpiece by imparting rotation to the tap as the tap is passed through the workpiece.

13. The punch and die assembly of claim 1 wherein the punch reciprocates between an upper and lower position and the matrix contained in the matrix placement chamber is compressed by pressure applied to an upper surface of the matrix by the downward movement of the punch toward the lower position.

14. The punch and die assembly of claim 1 wherein the punch reciprocates between an upper and lower position without compressing the matrix during operation.

15. A method for forming a punch lubrication matrix, said method comprising the steps of:
providing at least one piece of a flexible matrix composition formed from a porous and flexible multi-celled polymeric body containing a multiplicity of hollow communicating cells adapted to hold a lubricant therein and being devoid of an opening for a punch therethrough,
placing the matrix within a guide sleeve of a punch assembly in alignment with an axis of a punch and below a point of the punch,
driving the point of the punch through the matrix to thereby form a passage in the matrix that has a configuration corresponding to the punch point so as to accommodate the punch point therein during operation of the punch assembly and,
placing or maintaining the matrix within the punch assembly during operation thereof.

16. The method of claim 15 wherein a lubricant or cleaning liquid is applied to the matrix.

17. The method of claim 15 wherein an abrasive in particulate form is applied to the matrix.

18. The method of claim 15 wherein the punch and die assembly is placed within a punch press and a lubricant is dispensed from a punch press into the punch assembly for transferring the lubricant to the lubrication matrix.

19. The matrix of claim 7 wherein the matrix has about 60 to 100 pores per inch.

20. The matrix of claim 10 wherein the matrix has about 75 to 85 pores per inch.

21. The punch and die assembly of claim 1 wherein the at least one flexible matrix comprises at least a pair of matrix bodies in stacked relationship and wherein each matrix body has a different pore size or resistance to compression.

22. The punch and die assembly of claim 21 wherein the stacked pair of matrix bodies are constructed and arranged for one matrix body to retain and store lubricant or cleaning fluid squeezed from the other matrix body during operation.

23. A punch and die assembly for use in a punch press having an opening for holding the punch assembly, said punch assembly comprising,
a guide sleeve adapted to be mounted on the punch press;
a punch mounted for sliding movement in the guide sleeve and having a punch point at a lower end thereof for forming or punching a workpiece;
a stripper element located at the lower end of the guide sleeve that has at least one stripper opening aligned with a punch point to enable the punch point to pass therethrough for engagement with a workpiece,
a die aligned with the punch below the workpiece,
wherein the die includes a workpiece forming member, and
at least one flexible matrix contained in a matrix placement chamber as a part of the die adjacent to the workpiece forming member thereof,
said matrix comprising a porous elastic multi-cellular polymeric body containing a multiplicity of hollow communicating cells that are adapted to hold a lubricant in fluid communication with the sidewalls of at least the forming member.

24. In a punch and die assembly for use in a punch press, a flexible multi-cellular polymeric open celled lubrication matrix insert used on a punch point that provides increased lubrication and reduced stripping pressure.

25. The apparatus of claim 24 wherein the matrix insert is an integral polymeric open celled lubrication matrix insert used on a punch point which reduces the heat buildup that results from the punching process.

26. The punch and die assembly of claim 24 wherein the matrix insert is an integral polymeric open celled lubrication matrix insert used on a punch point that reduces the need to add lubrication to the surface of the material being processed.
